(19) United States
(12) Patent Application Publication
(10) Pub. No.: US 2022/0219503 A1
(43) Pub. Date: Jul. 14, 2022

(54) REAR AXLE FOR A TWO-TRACK VEHICLE AND TWO-TRACK VEHICLE WITH A REAR AXLE

(71) Applicant: Universität Siegen, Siegen (DE)

(72) Inventors: Tobias Niessing, Siegen (DE); Xiangfan Fang, Rodgau (DE); Timo Schlichting, Münster (DE)

(21) Appl. No.: 17/608,662

(22) PCT Filed: May 4, 2020
(86) PCT No.: PCT/EP2020/062274

§ 371 Date: Nov. 3, 2021

(30) Foreign Application Priority Data
May 6, 2019 (DE) 10 2019 111 714.3

(51) Int. Cl. B60G 21/05; B60G 3/20

(52) U.S. Cl. CPC B60G 21/051; B60G 3/20; B60G 2204/4222; B60G 2200/44; B60G 2200/46; B60G 2300/50; B60G 2200/464; B60G 2202/136; B60G 2204/1434; B60G 2204/148; B60G 2206/20; B60G 2200/21

(57) ABSTRACT

A rear axle for a two-track vehicle includes a first trailing arm, a first wheel carrier with a first wheel center and a first longitudinal strut, which form a first coupling mechanism that is effective in a longitudinal and/or a vertical direction of the vehicle. A second trailing arm and a second wheel carrier with a second wheel center and a second longitudinal strut form a second coupling mechanism that is effective in a longitudinal and/or a vertical direction of the vehicle, and a crossmember is firmly connected to the first trailing arm and to the second trailing arm and has a shear center. The first coupling mechanism has a first instantaneous center of rotation located on the front side and above the first wheel center, and the second coupling mechanism has a second instantaneous center of rotation located on the front side and above the second wheel center. A two-track vehicle having a chassis or an underbody includes such a rear axle arranged on the chassis or on the underbody.

### CROSS-REFERENCE TO RELATED APPLICATIONS

This application is a national phase application under 35 U.S.C. § 371 of International Patent Application No. PCT/EP2020/062274, filed May 4, 2020 (pending), which claims the benefit of priority to German Patent Application No. DE 10 2019 111 714.3, filed May 6, 2019, the disclosures of which are incorporated by reference herein in their entirety.

### TECHNICAL FIELD

The invention relates to a rear axle for a two-track vehicle, the rear axle having a first trailing arm, a first wheel carrier with a first wheel center and a first longitudinal strut, which form a first coupling mechanism that is effective in a longitudinal direction of the vehicle, a second trailing arm, a second wheel carrier with a second wheel center and a second longitudinal strut, which form a second coupling mechanism that is effective in a longitudinal direction of the vehicle. The invention also relates to a two-track vehicle having a chassis or an underbody and such a rear axle.

### BACKGROUND

Passenger car rear axles can be designed as rigid axles, semi-rigid axles and axles with independent wheel suspensions. Semi-rigid axles comprise torsion crank axles and twist beam axles.

In the case of semi-rigid axles, both wheels on the rear axle are physically connected to one another by means of an elastically deformable crossmember. In the case of the torsion crank axle, which belongs to this group, the crossmember lies in the position of the wheel center, is designed to be torsionally soft and connects the two wheels effectively in the middle via a corresponding wheel carrier in a torsionally soft and therefore semi-rigid manner. The wheel carriers are linked to the crossmember in the form of a fixed connection. The crossmember is connected to a body, in particular a body structure, via a flexible and torsionally soft trailing arm both on the left and right side of the vehicle. This design allows for a free wheel stroke movement, in particular an equilateral compression/rebound as a result of cornering, with very small changes in wheel position, in particular changes in toe and camber angle. In the case of a reversed wheel stroke movement, in particular an alternating compression/rebound, in which lateral forces are generated which also cause torsional moments around a vehicle longitudinal axis and a vehicle transverse axis, very strong changes in the wheel position would occur because the trailing arm is usually designed to be flexible and torsionally soft. In order to adjust the wheel position changes in a targeted manner, different transverse supports, for example, a Panhard rod, are introduced.

In contrast to the torsion crank axle, the twist beam axle has two rigid and torsionally stiff trailing arms. As with the torsion crank axle, the crossmember is designed to be rigid and torsionally soft. However, the crossmember is not located directly at the wheel center but lies close to the body mounting. The coupling of the two wheels with one-sided excitation is therefore less than with the torsion crank axle.

The torsionally soft and rigid properties are usually achieved in practice by the crossmember having an open profile shape extending over a large part of the length, for example, in a U or C shape, which merges into a closed profile in the edge regions. The profile is usually closed by means of additional welded-in metal sheets. This means that different cross sections can be realized in the crossmember. Alternatively, they can also be achieved by reshaping a tubular profile.

The rigid and torsionally stiff trailing arms establish a connection from the wheel to the body, wherein the connection of the wheel carrier to the arm is usually fixed and the connection to the body is realized in an articulated manner by means of resilient rubber bearings. In this case, the axle is designed such that the body mounting is positioned in front of the wheel center in the direction of travel, so that the wheels are pulled.

An essential advantage of the axle in terms of driving dynamics is the resulting different wheel positions in symmetrical, equilateral, and antimetric, reciprocal compression/rebound processes. In the case of an equilateral wheel stroke, for example, as a result of a change in load, the wheels swivel around the body bearings, so that they form an instantaneous pivot point, the instantaneous center of rotation. The wheel center is thus connected to the instantaneous center of rotation for the equilateral deflection by means of the trailing arm in the form of a direct physical connection. The position of the instantaneous center of rotation essentially determines the pitch and oblique suspension behavior of the vehicle.

An equilateral stroke movement leads to a largely constant wheel position above the spring deflection due to the rotation of the trailing arm around the body bearings. In contrast, when body rolling, for example, as a result of cornering, there are significant changes in the wheel angle. This is due to the fact that the wheels now approximately execute a rotary movement about the axis of rotation which is formed by the wheel-associated body bearing and the shear center of the crossmember profile. The roll center as the center of rotation of the rolling movement is therefore influenced by the positions of the body bearings and the shear center. The wheel angle changes can therefore be influenced by the positioning of the crossmember in relation to the trailing arms and by the profile shape of the crossmember, in particular the position of the shear center, such that a desired, usually slightly understeering, driving behavior sets in. This self-steering behavior of the rear axle is essentially determined by the changes in the wheel position.

Since both the crossmember and the trailing arm are elastically deformable, a toe-out angle can occur on the outside wheel when cornering, which causes a tendency to oversteer. In addition, the lateral forces in the body are supported by rubber bearings. The flexibility of the rubber bearing also causes the axle body to twist, which leads to a further increase in the toe-out angle.

One possibility to reduce this toe-out tendency is the stiffer design of the trailing arm and its support on the crossmember by further components such as the spring-damper seat, which is usually welded on one side to the trailing arm and on the other side to the crossmember and thus provides a highly rigid support for the trailing arm. This improves a toe, camber and lateral stiffness of the axle.

Another possibility of counteracting the natural toe-out tendency of the twist beam axle is that of increasing the radial rubber spring rates in the longitudinal direction of the vehicle, corresponding to a high spring constant kₓ. However, this conflicts with the greatest possible longitudinal comfort, which requires a low radial rigidity, corresponding to a small spring constant kₓ. In order to defuse this conflict of objectives, for example, track-correcting or adjusted rubber bearings are introduced.

The camber and toe stiffness as well as the lateral stiffness, which reflects the flexibility of the axle in the transverse direction of the vehicle, are therefore central properties of a twist beam axle.

In the following, the installation space conditions in the rear carriage of a small car equipped with a twist beam axle will also be addressed. Such vehicles usually have a drive concept with a front engine and a front drive. In this case, the installation space in front of the wheel center is essentially delimited by the fuel tank, and behind the wheel center, it is delimited by the components of the exhaust system. The placement of the spare wheel is not supposed to play a role in this consideration, as it can now also be replaced by space-saving repair kits.

In the case of an electric vehicle, a fuel tank and all components associated with the exhaust system can be omitted. The region in the middle of the vehicle floor can be used to accommodate the battery which usually requires a large, cohesive, regularly shaped installation space. In the case of a conventional twist beam axle, this installation space ends in front of the crossmember. However, the lateral delimitation of the installation space for the battery by the trailing arm and the body bearing is minimal.

For solving these problems, a reversed twist beam axle concept has been proposed and disclosed in document CN 105365543 A. This concept comprises a relocation of the connection of the axle to the body in the direction of travel toward the rear at the end of the body. In this way, the trailing arm is placed behind the wheel center as a direct physical connection between the wheel and the body. The crossmember located on this connection is thus moved behind the wheel center. The pulled twist beam axle becomes a pushed twist beam axle as a result of this reversal. According to document CN 105365543 A, this reversed twist beam axle has the following advantages: a.) 300-450 mm of regular installation space in the longitudinal direction of the vehicle to accommodate a drive battery of an e-vehicle. The battery can be placed behind the wheel center and in front of the crossmember. b.) Crossmember and trailing arm are made of high-strength materials, wherein the crossmember has high flexural rigidity and the trailing arm not only has high compressive and bending strength but also high energy absorption in the axial direction. As a result, the drive battery is protected from damage by the axle beam in both a rear and side crash. c.) Reinforcement measures in the body are described to accommodate this reversed twist beam axle in the body. d.) The natural toe-out tendency of the conventional twist beam axle in the event of a lateral force or when cornering is reversed to a toe-in tendency for the wheel on the outside of the curve. This automatically results in positive self-steering behavior.

There are further possibilities for improvement with regard to the relocation of the body bearings behind the wheel center. Since they represent the center of rotation for the equilateral wheel stroke, the instantaneous center of rotation for equilateral deflection also moves behind the wheel. A braking process thus results in a negative brake support which leads to a considerable increase in the pitch of the vehicle. This can be perceived as particularly unpleasant by the vehicle occupants. The position of the instantaneous center of rotation does not have to be determined by the physical position of the link connection on the body structure, as is the case with the twist beam axle. In the case of multi-link axles, the position of the instantaneous center of rotation can also be determined virtually through the interaction of a plurality of spatially arranged links. For example, the instantaneous center of rotation of a front axle with a double transverse link above and below can be determined by the position of the two links.

In this case, the two axes of rotation of the upper and lower transverse links, which run obliquely to one another in a side view of the vehicle, intersect around the bearings inside the vehicle, which go through the ball joints on the outside of the vehicle, at a point behind the wheel center of the front wheel. This ensures the desired brake support for the front wheel.

Said instantaneous center of rotation is decoupled from the link by means of physical bearings and is defined virtually by their spatial position relative to one another and can therefore also be varied over a wide range by the link orientations. The brake support can thus be varied according to the requirements or customer wishes.

The objective of the invention is that of obtaining the advantages of the reversed twist beam axle known from document CN 105365543 A and at the same time compensating for its disadvantages, in particular the improvable position of the instantaneous center of rotation and the brake support. For this purpose, the instantaneous center of rotation is supposed to be spatially decoupled from the position of the body bearings and moved in front of the wheel center. This objective can be realized with the use of the virtual instantaneous center of rotation by means of a plurality of spatially arranged links. Since a design with two links and corresponding bearings requires further improvement possibilities with regard to the lateral stiffness and camber stiffness and the transverse dynamic properties of the axle, a Watt linkage comprising a plurality of links and bearings is designed such that, in addition to the freedom for the entire system of a multi-link torsion axle, the required high lateral and camber stiffnesses can be restored.

From document DE 10 2007 007 439 A1, a composite axle of a two-track vehicle is known, comprising longitudinal arms articulated on the vehicle body, which extend essentially in the longitudinal direction of the vehicle, guiding the so-called wheel carriers for the two wheels, which are torsion-flexible in the transversal direction of the vehicle and/or elastically supported in the transverse direction; further comprising a twist beam connected to both wheel carriers, resistant to bending, torsionally soft at least in portions and also forming a torsion axle that extends in the transversal direction of the vehicle, said longitudinal arms connecting to the twist beam by means of a torsionally rigid connection at least in relation to the transversal axis of the vehicle, so that in the side view, the torsion axle of the twist beam and the longitudinal arms are disposed on the opposite sides in relation to the wheel center; and further comprising a lateral force guiding element that is finally supported between the twist beam or a wheel carrier and the vehicle body; and suspension rings that are associated with the wheels of the axle and are tensed between said wheels and the vehicle body, wherein the twist beam is essentially U-shaped when seen in the horizontal plane and comprises branches connected to the wheel carriers below the horizontal wheel center plane and embodied such that when seen from the side, the ratio of the horizontal distance between said torsion axle and the wheel center to the horizontal distance between the body-side articulation point of the longitudinal arm and the wheel center is essentially greater than 0.25.

According to document DE 10 2007 007 439 A1, the longitudinal arms are flexible in the transverse direction and rigid in the vertical direction; a lateral guide element is required for lateral guidance; in addition to negatively impacting the installation space, there are further disadvantages when using lateral guide elements; the longitudinal arms which, proceeding from the wheel carriers, extend in the direction of the front of the vehicle and are connected at the front to the chassis or the underbody, are connected to the twist beam via torsionally rigid connections; the trailing arms which, proceeding from the wheel carriers, extend in the direction of the rear of the vehicle or the front of the vehicle and are connected to the chassis or the underbody at the rear side or at the front side, are not directly connected to one another; a distance between the associated front body bearing and the shear center in the longitudinal direction is in each case Δx=a+b, wherein a corresponds to the distance between the body-side articulation point of the longitudinal arm and the wheel center, and b corresponds to the distance between the torsion axle of the twist beam and the wheel center; a ratio of a distance between a torsion axle of the twist beam and a wheel center and a distance between an articulation point and a wheel center, corresponding to b/a or a transmission ratio change of camber angle and roll angle, is greater than 0.25; the twist beam is arranged below the wheel center; parallel and identical toe angle changes are effected left and right on both wheels; the underlying concept mainly relates to an offset of the position of the twist beam behind the wheel center due to the camber behavior; second longitudinal arms are arranged on the other side of the first arm with respect to the wheel center; the twist beam is bent and connected directly to the wheel carrier; the twist beam is always connected to the front longitudinal arm below the wheel center; for a lateral force support, lateral support elements are required; both wheels are coupled via rigid twist beams and supported below the wheel center by means of a Panhard rod; a Panhard rod has a negative effect on an equilateral stroke because it can cause the wheels to offset transversely; the underlying concept mainly relates to a negative camber on the wheel on the outside of the curve and the same change on the wheel on the inside of the curve, resulting inevitably in a negative camber for the wheel on the outside of the curve; the degrees of freedom of the body-side articulation points, the bearings of the upper trailing arm and the pivot bearings between the wheel carrier and the upper trailing arm are not defined.

### SUMMARY

The problem addressed by the present invention is that of structurally and/or functionally improving a rear axle of the initially described type. The problem addressed by the present invention is also that of structurally and/or functionally improving a vehicle of the initially described type.

The problem is solved by a rear axle and a vehicle as disclosed herein.

Unless otherwise stated or the context does not indicate otherwise, the specifications “longitudinally,” “transversely,” “vertically,” “rear side,” and “front side” refer to a vehicle for which the rear axle is used or which has the rear axle.

The rear axle can be an axle to be attached or attached behind a center of gravity of the vehicle. The rear axle can be used to accommodate rear wheels.

The trailing arms can be arranged with their longitudinal axes at least approximately in the longitudinal direction of the vehicle. The trailing arms can be used to guide the wheel carriers at least approximately vertically and longitudinally and to support longitudinal forces and braking response moments as well as lateral forces on the chassis or on the underbody.

The wheel carriers can be arranged with their longitudinal axes at least approximately in the vertical direction of the vehicle. The wheel carriers can be connected to the chassis or the underbody via the trailing arms, the longitudinal struts and the joints. The wheel carriers can have wheel bearings, articulation points on the wheel side for the links as well as the body suspension and fastening points for brake calipers in the case of disk brakes or for anchor plates in the case of drum brakes. The wheel carriers can be guided in relation to the chassis or the floor assembly. The wheel centers can be points on the wheel carriers that are assigned to a wheel axle.

The longitudinal struts can be used to guide the wheel carriers and to support longitudinal forces and braking response moments on the chassis or on the underbody. The longitudinal struts can be arranged far outside in the transverse direction. The longitudinal struts can be arranged further out in the transverse direction than is the case with previously known rear axles.

The coupling mechanisms can be effective in the longitudinal direction of the vehicle and in the vertical direction of the vehicle. The coupling mechanisms can be effective in a plane that is spanned by a vehicle longitudinal axis and a vehicle vertical axis or in a plane parallel thereto. The coupling mechanisms can be designed as a Watt linkage. By means of the Watt linkage, the instantaneous center of rotation can be decoupled from the position of the crossmember in order to create a larger, coherent installation space in the center of the vehicle. The coupling mechanisms can be used to convert rotatory pivoting movements in one plane into an approximately straight movement. The coupling mechanisms can be used to convert movements of points of the trailing arms and the longitudinal struts on a circular path portion into movements of the wheel centers on a lemniscate portion.

The crossmember can be arranged transversely. The crossmember can be used to guide the wheel carriers and transmit forces between the wheel carriers. The crossmember can be arranged far to the rear in the longitudinal direction. The crossmember can be arranged further to the rear in the longitudinal direction than is the case with previously known rear axles. The crossmember can be designed to be more rigid and torsionally soft. The crossmember can have an open profile shape extending over a large part of its length, for example, in a U or C shape.

Due to the wide arrangement of the longitudinal struts far to the outside in the transverse direction and/or of the crossmember far to the rear in the longitudinal direction, additional installation space can be made usable. The additional installation space can be used for storage devices for electric energy.

The instantaneous centers of rotation can occur at the intersections of extensions of the trailing arm and the longitudinal struts. The instantaneous centers of rotation can be virtual instantaneous centers of rotation. The instantaneous centers of rotation are arranged such that the result is a positive brake support and/or a positive oblique suspension angle.

The shear center of the crossmember can be arranged at the rear. The shear center of the crossmember can be arranged above the wheel centers. The shear center of the crossmember can be the point of a profile cross section of the crossmember through which a resultant of the transverse forces must pass in order to achieve a torsion-free force effect or to exert no torsion on the cross section. The shear center can coincide with a center of gravity of the crossmember. The shear center can deviate from the center of gravity. The shear center can be opposite the center of gravity. The shear center can lie outside the profile cross section.

The trailing arms can each be connectable to a chassis or an underbody by means of a first joint. The trailing arms and the wheel carriers can each be connected to one another by means of a second joint. The wheel carriers and the longitudinal struts can each be connected to one another by means of a third joint. The longitudinal struts can each be connectable to the chassis or the underbody by means of a fourth joint. The joints can have such degrees of freedom that the rear axle has a degree of freedom f=2, taking into account a shear center of the crossmember as a mechanically idealized cylindrical joint.

The first joints, the third joints, and the fourth joints can each have a degree of freedom f=3 and the second joints can each have a degree of freedom f=1.

The first joints, the second joints, and the fourth joints can each have a degree of freedom f=3 and the third joints can each have a degree of freedom f=1, and the rear axle can have at least one first additional link and at least one second additional link. The additional links can be designed as torque supports with integral links.

The first joints, the third joints, and the fourth joints can each have a degree of freedom f=3 and the second joints can each have a degree of freedom f=2, so that the rear axle has a steering axis and is steerable. The second joint can have an axis of rotation that passes through the third joint. A kinematic steering axis can be formed by means of the second joint and the third joint.

The joints can be designed as a ball joint, swivel joint, double ball joint and/or by means of concentric or adjusted combined joints. The joints can be designed by means of rubber-metal bearings, roller bearings, slide bearings and/or rubber elements. The joints with a degree of freedom f=3 can be designed as ball joints, in particular as rubber-metal bearings. The joints with a degree of freedom f=2 can be designed as combination joints with two axes of rotation or by means of two ball joints. The joints with a degree of freedom f=1 can be designed as swivel joints, as roller bearings or slide bearings or by means of two rubber elements.

The second joints and the third joints can each be arranged offset from one another in the transverse direction. The second joints and the third joints can each be arranged offset from one another in the transverse direction such that a lateral force-induced, resulting camber angle change of a wheel carrier on the outside of the curve is reduced. The second joints and the third joints can each be offset from one another in the transverse direction such that a torque generated by an increase in wheel contact force in the vertical axis of a wheel on the outside of the curve about the vehicle longitudinal axis around the second joint is partially a torque that is generated by a lateral force of a wheel on the outside of the curve, compensates and thus reduces a change in the camber angle of this wheel.

The second joints and the third joints can each be arranged offset from one another in the longitudinal direction such that a predetermined caster angle can be set.

The trailing arms can be designed to be rigid and torsionally stiff. The longitudinal struts can be designed to be flexible, torsionally soft and kink-resistant.

The fourth joints can each have a lower rigidity in all directions than the first joints, the second joints and/or the third joints. The first joints, the second joints and/or the third joints can each have a higher rigidity in all directions than the fourth joints. The joints can be designed elastokinematically such that a high level of ride comfort and secure lateral guidance are ensured.

The first joints and the shear center of the crossmember can be arranged such that a roll moment has a larger torsional component and a smaller camber component or bending component. The torsional component can be greater than the camber component. The camber component can be smaller than the torsional component. By arranging the first joints behind and above the wheel centers in combination with a shear center of the crossmember close to the body, an axis of rotation for reciprocal wheel stroke movements can approximately be defined. As a result, a high torsional component can be present when rolling. A distance between the first joints and the shear center in the longitudinal direction can in each case correspond to the distance between the crossmember and the associated rear body bearing. The crossmember can lie in the longitudinal direction between the first joints and the wheel center. A distance between the first joints and the crossmember can be smaller than a distance between the crossmember and the wheel center.

The vehicle can be a motor vehicle. The vehicle can be a passenger car. The vehicle can be an electric vehicle. The vehicle can have storage devices for electric energy. The storage devices can be arranged in the region of the rear axle. The storage devices can be arranged in the transverse direction at least in portions between the trailing arms and/or the longitudinal struts. The storage devices can be arranged in the longitudinal direction at least in portions in front of the crossmember. The vehicle can have wheels. When driving straight ahead, the wheels of the vehicle can be arranged in two tracks next to one another. The vehicle can have four wheels. The vehicle can have a chassis. The rear axle can be part of the chassis. The vehicle can have a body. The body can be not self-supporting or self-supporting. A not self-supporting body can have a chassis. A self-supporting body can have an underbody. The vehicle can have a front and a rear. The vehicle can extend in a longitudinal direction, a transverse direction, and a vertical direction. The front and the rear can be in the longitudinal direction. The longitudinal direction can run parallel to a roadway. The transverse direction can run perpendicularly to the longitudinal direction and parallel to the roadway. The vehicle can have two axles. The vehicle can have a front axle. The front axle can be an axle mounted in front of a center of gravity of the vehicle. The front axle can be steerable. The rear axle can be an axle attached behind a center of gravity of the vehicle. The rear axle can be an axle attached behind a center of gravity of the vehicle. The rear axle can be connected to the chassis or the underbody with its trailing arms and longitudinal struts. The rear axle can be connected in an articulated manner to the chassis or the underbody with its trailing arms and longitudinal struts.

With the invention, the advantages of the reversed twist beam axle from document CN 105365543 A are obtained and disadvantages are compensated at the same time. The instantaneous center of rotation is spatially decoupled from the positions of the body bearings and moved in front of the wheel center. The rear axle according to the invention is structurally easy to realize. Disadvantages with regard to lateral stiffness and camber stiffness are reduced or avoided without additional lateral guide elements. Impairment of transverse dynamic properties is reduced or avoided. In addition to the freedoms for the entire system, the required high lateral and camber stiffnesses are restored. The rear axle according to the invention can also be called a multi-link torsion axle. The multi-link torsion axle according to the invention can be close to the principle of the twist beam axle and can be distinguished from the principle of the torsion crank axle.

In the following, embodiments of the invention will be described in more detail with reference to the drawings.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a schematic side view of an exemplary section of a rear axle for a two-track vehicle having a Watt linkage;

FIG. 2 is a schematic sectional plan view of an exemplary rear axle for a two-track vehicle having a Watt linkage;

FIG. 3 is a schematic axonometric view of a rear axle for a two-track vehicle having a Watt linkage;

FIG. 4 is a schematic axonometric view of a rear axle for a two-track vehicle having a Watt linkage and alternative mounting;

FIG. 5 is a schematic axonometric view of a rear axle for a two-track vehicle having a Watt linkage and alternative mounting;

FIG. 6 is a schematic axonometric view of an embodiment of a rear axle for a two-track vehicle having a Watt linkage;

FIG. 7 is a side view of an embodiment of a rear axle for a two-track vehicle having a Watt linkage;

FIG. 8 is a front view of a joint designed by means of two ball joints between a trailing arm and a wheel carrier;

FIG. 9 is a side view of a joint designed by means of two ball joints between a trailing arm and a wheel carrier;

FIG. 10 shows a joint designed by means of two rubber bearings between a trailing arm and a wheel carrier;

FIG. 11 is a plan view of an approximately instantaneous roll axis of a rear axle for a two-track vehicle having a Watt linkage with deflection of a left wheel;

FIG. 12 is a plan view of installation space conditions of a rear axle for a two-track vehicle having a Watt linkage;

FIG. 13 shows a kinematic camber compensation on a rear axle for a two-track vehicle having a Watt linkage,

FIG. 14 shows a kinematic camber compensation on a rear axle for a two-track vehicle having a Watt linkage,

FIG. 15 illustrates a caster angle on a rear axle for a two-track vehicle having a Watt linkage; and

FIG. 16 illustrates a steerable rear axle for a two-track vehicle having a Watt linkage.

### DETAILED DESCRIPTION

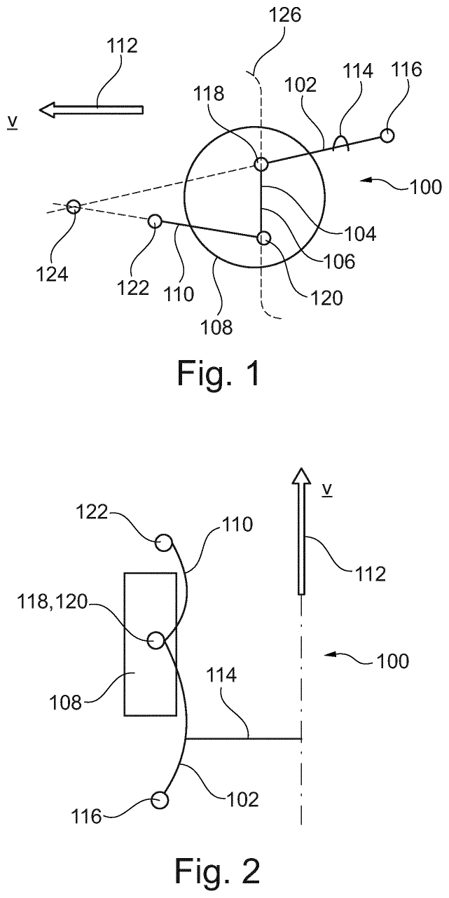

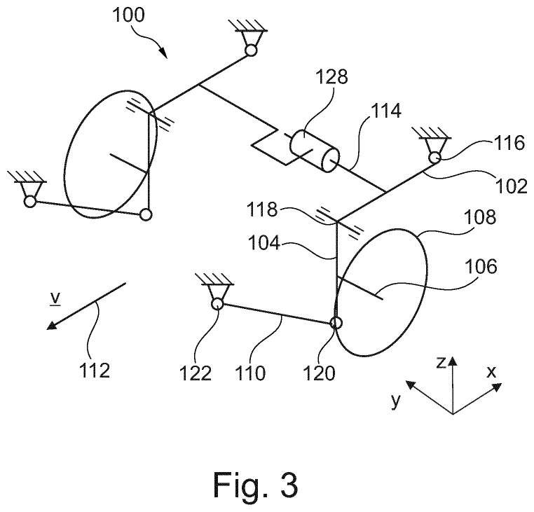

FIG. 1 is a side view of one side of a rear axle 100 of a two-track vehicle having a Watt linkage. FIG. 2 is a sectional plan view of the rear axle 100. FIG. 3 is an axonometric view of a specific embodiment of the rear axle 100.

The present description relates only to one side of the rear axle, the other side of the rear axle 100 is designed correspondingly. Directional specifications relate to an installation position of the rear axle 100 in a vehicle. In a Cartesian coordinate system, the longitudinal direction runs in the x direction, a transverse direction in the y direction and a vertical direction in the z direction.

The rear axle 100 has a trailing arm 102, a wheel carrier 104 with a wheel center 106, and a wheel 108, and a longitudinal strut 110. The trailing arm 102, the wheel carrier 104, and the longitudinal strut 110 form a coupling mechanism designed as a Watt linkage. The coupling mechanism is effective in the longitudinal direction and/or in the vertical direction, i.e., in a plane spanned by x and z. A forward direction of travel is denoted with 112. The rear axle 100 has a crossmember 114 running in the transverse direction, which is firmly connected to the trailing arms 102 on both sides of the rear axle 100.

The trailing arm 102 can be or is connected to a chassis or an underbody of a vehicle by means of a first joint 116. The trailing arm 102 and the wheel carrier 104 are connected to one another by means of a second joint 118. The wheel carrier 104 and the longitudinal strut 110 are connected to one another by means of a third joint 120. The longitudinal strut 110 is connected to the chassis or the underbody by means of a fourth joint 122.

The coupling mechanism has a virtual instantaneous center of rotation 124 which occurs at an intersection of the longitudinal axes of the trailing arm 102 and the longitudinal strut 110 and lies in the longitudinal direction at the front of the wheel center 106 and in the vertical direction in the construction position in the region of the wheel center 106 or above the wheel center 106. The construction position can also be called ML2 position and is a result of curb weight+occupants. The curb weight can also be called ML1 and results from an empty, ready-to-drive vehicle with complete equipment and operating means+90% tank filling+75 kg luggage. The weight of an occupant is assumed to be 75 kg (68 kg+7 kg). By means of the coupling mechanism, rotary pivoting movements of the trailing arm 102 and the longitudinal strut 110 are converted into an approximately straight-line movement of the wheel carrier 104, wherein the wheel center 106 moves on a lemniscate portion 126.

An essential task of the rear axle 100 is that of bringing the instantaneous center of rotation 124 in front of the wheel center 106 by integration into a Watt linkage. However, due to an equilateral spring movement, the positions of the links 102, 110 change with respect to one another, i.e., the position of an intersection of the link extensions and thus the position of the instantaneous center of rotation 124 are changed via a wheel stroke (in the z-direction). Above a certain limit value, the control arms 102, 110 are positioned in parallel and, in addition, the instantaneous center of rotation 124 swings around behind the wheel center 106. This swinging should take place after a highest possible wheel stroke and, in particular, should not be able to be achieved by a static load increase because otherwise unpleasant and unforeseen braking pitch movements can occur. The use of the rear axle 100 in the context of electromobility means that these usually heavier electric vehicles are equipped with a harder body suspension, so that the usual natural frequencies of the body can be maintained. This leads to smaller spring deflections as a result of changes in load and facilitates the movement of the instantaneous center of rotation 124 during compression.

The rear axle 100 can also be called a multi-link torsion axle and, as shown in FIG. 1, FIG. 2, and FIG. 3, can be described with a model in which the trailing arms 102, the wheel carriers 104, and the longitudinal struts 110 are regarded as beams and the joints 116, 118, 120, 122 are shown as bearings and a cylindrical joint 128 is assigned to the crossmember 114 in a vehicle center plane.

The original trailing arm 102 of the reversed twist beam axle is a beam that is connected to the body via the first joint (rubber bearing) 116 which is depicted as a bearing. The trailing arm 102, regarded as a beam, is connected to the wheel carrier 104, which can also be regarded as a beam in the model, in the second joint 118 which is depicted as a bearing. In the middle of the wheel carrier 104, which is regarded as a beam, a bearing is arranged around which the wheel 108 can rotate. At the lower end of the wheel carrier 104, regarded as a beam, is a third joint 120, depicted as a bearing, on which the longitudinal strut 110, regarded as a beam, is hinged. The longitudinal strut 110, regarded as a beam, is connected on the body to the fourth joint 122, depicted as a bearing.

The beams and the bearings form a Watt linkage in the longitudinal direction x of the vehicle. During a wheel stroke movement, the wheel 108 then moves virtually around the instantaneous center of rotation 124 which, in the side view, results from an intersection of the extension lines of the trailing arm 102 and the longitudinal strut 110. Between the right trailing arm and the left trailing arm 102, the crossmember 114 of the rear axle 100 is arranged, which can be mechanically approximately modeled in the middle at its shear center by the cylindrical joint 128. The two trailing arms 102 and the crossmember 114 are firmly connected to one another.

The instantaneous center of rotation 124 is thus decoupled from the physical position of the first joint 116 and can be varied in a specific range by adjusting the trailing arm 102 and the longitudinal strut 110. The instantaneous center of rotation 124 should lie in front of the wheel center 106 of the wheel 108 in order to enable positive brake support and thus avoid an unpleasant excessive braking pitch. In addition, the instantaneous center of rotation 124 should lie above the wheel center 106 in order to enable good oblique suspension behavior.

All of the above-mentioned joints 116, 118, 120, 122 depicted as bearings must now be assigned to specific translational and rotational freedoms, which can take place for the entire rear axle 100 by considering the freedom.

In the case of a non-steerable rear axle initially taken into consideration, two freedoms, corresponding to a stroke movement and a rolling movement, must be provided. The degree of freedom of the entire axle can be described using the equation

$$D O F = 6 \cdot ( l ) - {\sum }_{i}^{g} ( 6 - {f}_{i} ) - r = 2 ,$$

Wherein

l: Number of beam elements
fᵢ: Degree of freedom for the g bearings (g=9 for the entire axis)
r: Intrinsic rotation of the two longitudinal struts 110 (r=2)

Viewed individually, each beam element (102, 104, 110) has six degrees of freedom. One of the possible configurations is that the joints 116, 120, 122, regarded as bearings, are designed as ball joints, each with three rotatory degrees of freedom (fᵢ=3) and that the second joint 118, regarded as a bearing, is designed as a swivel joint (fᵢ=1). The shear center of the crossmember 114 is modelled as a cylindrical joint 128 ((fᵢ=2). This results in DOF=2 if the freedom of rotation of the longitudinal strut 110, regarded as a beam, about its own longitudinal axis (r) is added. In the case of the rear axle 100, the trailing arms 102 and/or longitudinal struts 110 can be designed to be rigid, so that an additional lateral guide element can be omitted. Lateral forces are supported on the body bearings.

The design of the second joint 118, regarded as a bearing, as a swivel joint between the wheel carrier 104 and the trailing arm 102 is also particularly suitable for ensuring a high level of lateral force and camber stiffness as well as sufficient toe stiffness, since torques resulting from reaction forces at a wheel contact point can be transferred well to the trailing arm 102, wherein the trailing arm 102 is supported by the crossmember 114 and the two first joints 116 designed, for example, as rubber bearings. In this way, it ensures toe and camber stability without the need for additional lateral guide elements, such as a Panhard rod or a Watt linkage lying transversely to the vehicle direction, which impair an installation space between the wheels 108.

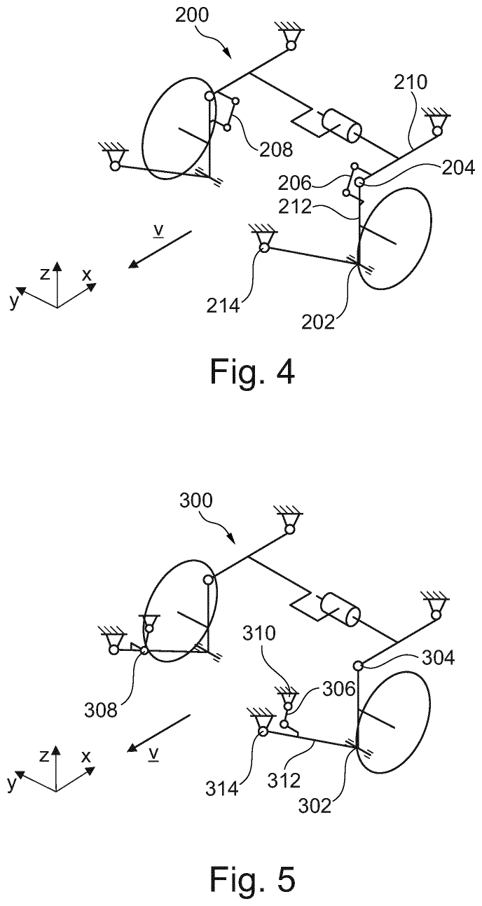

FIGS. 4 and 5 are axonometric views of rear axles 200, 300 with an alternative mounting. Deviating from the rear axle 100 according to FIG. 3, another joint regarded as a bearing, for example, the third joint 202, 302, can also be designed as a swivel joint, while the second joint 204, 304, regarded as a bearing, is designed as a ball joint.

For this purpose, two additional links are introduced as integral links 206, 208, 306, 308 which are now required due to the no longer negligible intrinsic rotations. The integral links are either mounted between the trailing arm 210 and the wheel carrier 212 with one ball joint each (integral link 206, 208), or between the body structure 310 and the longitudinal strut 312 (integral link 306, 308). Cardan joints can be replaced with integral links or torque supports. Instead of the integral links 206, 208, 306, 308 or the torque supports with joints 204, 304, 214, 314 designed as ball joints, pure cardan joints can therefore also be used.

Moreover, reference is made in particular to FIG. 1 to FIG. 3 and the associated description with regard to the rear axles 200, 300.

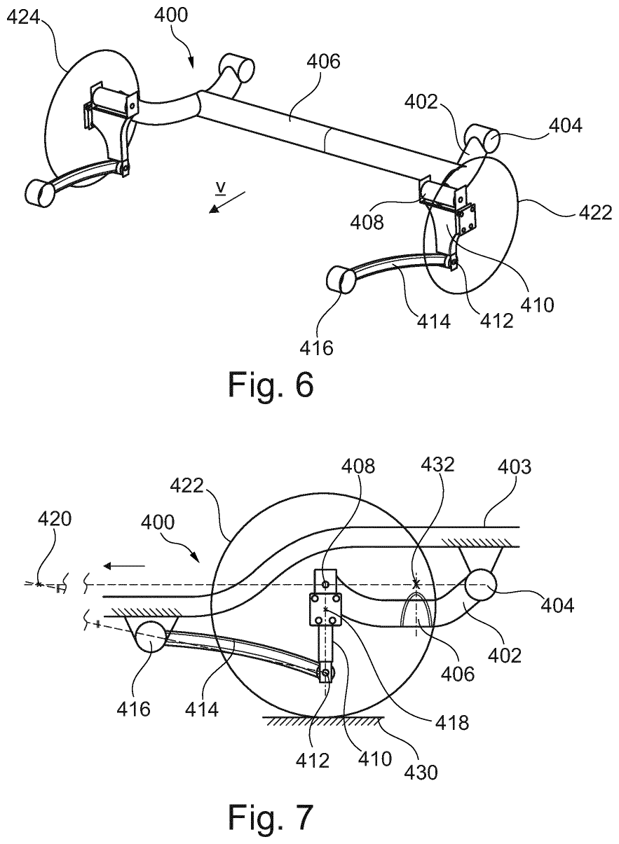

FIG. 6 is an axonometric view of a constructional design of a rear axle 400 for a two-track vehicle having a Watt linkage that can be easily realized and saves installation space and costs; FIG. 7 is a side view of the rear axle 400.

A trailing arm 402, which is supported on the body 403 by means of a first joint 404 designed as a rubber bearing, is firmly connected to a crossmember 406, for example, by means of a welded connection, and to the wheel carrier 410 with a second joint 408 designed as a swivel joint. The wheel carrier 410 is connected at the bottom with a third joint 412, designed as a ball joint, to a longitudinal strut 414 which does not have to transmit any torques. The longitudinal strut 414 is connected to the body 403 via a fourth joint 416 designed as a rubber bearing.

The ball bearings identified in the basic concept are in this case all provided as rubber or rubber-metal bearings. Rubber bearings can replace the ideal kinematic ball joints with three rotational degrees of freedom in a particularly cost-effective manner. The rubber bearings are significantly more cost-effective than ball joints and also assume damping functions for reducing vibrations and noises in the vehicle interior.

The rear axle 400 is characterized in that the trailing arm 402 and the longitudinal strut 414 are adjusted relative to one another in the side view such that their virtual extensions intersect in the side view at a point in front of the wheel center 418.

This point now represents the instantaneous center of rotation 420 for an equilateral deflection. In this way, brake support can be influenced in a targeted manner by an inclination of the trailing arm 402 and the longitudinal strut 414, so that a predefined pitching behavior can be achieved. For a favorable oblique suspension behavior, the positioning of the instantaneous center of rotation 420 above the wheel center 418 is desirable, since an evasive movement of the wheel 422 becomes possible when driving over an obstacle.

The freedom of movement of the multi-link torsion axle is specified by the design of the joints 404, 408, 412, 416. Toe and camber stability as well as lateral force stability is ensured by the second joint 408 which transfers the lateral forces at a wheel contact point and the resulting torques to the rigid trailing arms 402 and by means of the crossmember 406 to the opposite side of the vehicle and to the first joints 404.

It is also possible to realize the second joint 118 as a swivel joint arranged largely in the transverse direction of the vehicle with a laterally supported roller bearing, but also as slide bearings (see FIG. 16) which have both a very high radial and a high axial rigidity.

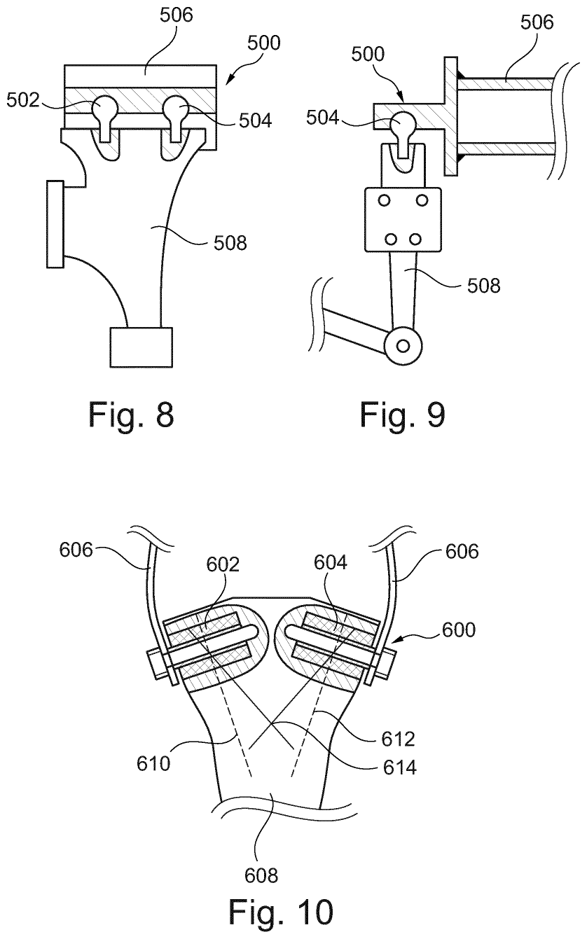

It is also possible to realize the second joint 118, 500 by means of two ball joints 502, 504 which allow freedom of rotation and have a high level of lateral stiffness. FIG. 8 is a front view of a second joint 118, 500, designed by means of two ball joints 502, 504, between a trailing arm 506 and a wheel carrier 508; FIG. 9 is a side view of the second joint 118, 500.

For cost reasons, for example, the second joint 118, 600 can be realized by means of two rubber elements 602, 604 arranged in a concentric or adjusted manner in order to allow for both the freedom of rotation and a high lateral force and camber rigidity. FIG. 10 shows a second joint 118, 600, designed by means of two rubber elements 602, 604, between a trailing arm 606 and a wheel carrier 608. The rubber elements 602, 604 have pressure lines 610, 612. A spring center of gravity is denoted with 614.

The crossmember 406 of the rear axle 400 is rigid and torsionally soft and arranged close to the first joint 404. In this way, a comfortable, low degree of coupling of the individual wheels 422, 424 is achieved. Furthermore, the required clearance of the crossmember 406 is kept low because it rotates about the first joints 404 during deflection. The installation space requirement is thus further minimized.

The first joints 404 located behind the wheel center 418 automatically generate favorable toe-in behavior as a result of cornering in order to increase the driving safety of the vehicle.

For the first joints 404, designed as rubber bearings, a lower radial stiffness (small kx) can now be provided in coordination with the desired toe stiffness than in the case of the conventional twist beam axle. Furthermore, the fourth joint 416, designed as a rubber bearing, can be designed to be soft in the radial direction. The combination of the elastokinematic design of the bearing stiffnesses of the first joint 404 and the fourth joint 416 as well as the joint stiffnesses of the second joint 408 and the third joint 412 can greatly improve ride comfort without having to compromise with regard to toe stiffness.

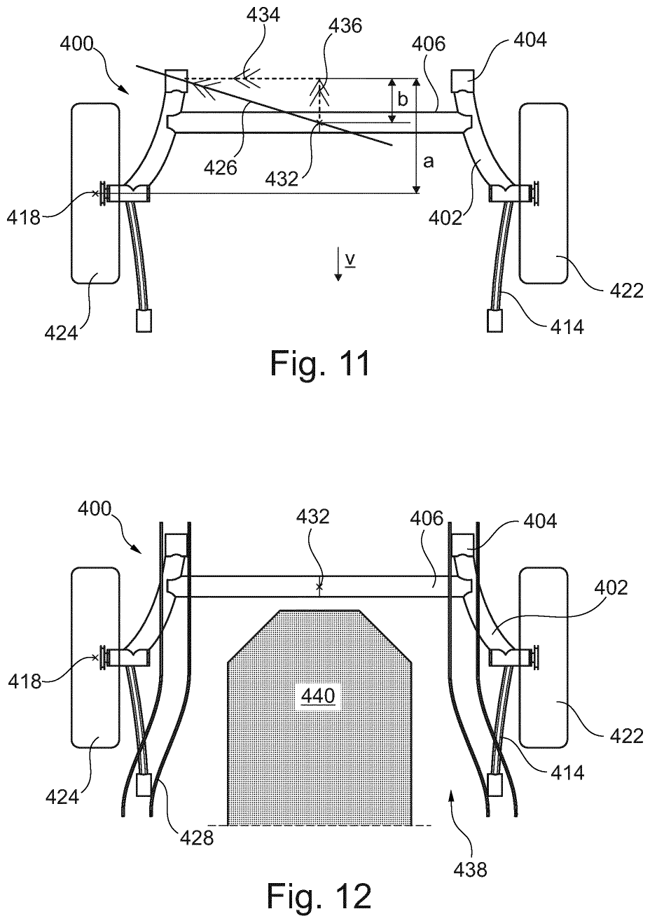

Without taking into account the longitudinal strut 414, FIG. 11 is a plan view of an approximately instantaneous roll axis 426 of the rear axle 400 with deflection of a left wheel 424; FIG. 12 is a plan view of the installation space conditions of the rear axle 400.

The body 403 has longitudinal members, such as 428, which are arranged in the rear region of the vehicle well above the wheel center 418, which means that the first joints 404 also lie above the wheel centers 418. In this way, a simple connection of the wheel suspension to the body 403 is ensured. At the same time, the torsionally soft crossmember 406, which is firmly connected to the trailing arm 402, is also arranged far above the roadway 430. In order to avoid a collision of the crossmember 406 with the body 403 during compression, the trailing arm 402 is designed to be curved downwards. In combination with the profile of the crossmember 406 and its orientation angle, the shear center 432 of the profile can be positioned above the wheel center 418. In order to further amplify this effect, a bending of the crossmember 406 at a right angle can be provided.

An axis of rotation is defined between the first joint 404 and the shear center 432 of the crossmember 406 (FIG. 11), which is called the instantaneous roll axis 426. The reciprocal stroke movements of the wheels 422, 424 when cornering (rolling) take place approximately around the instantaneous roll axis 426. It is thus apparent that, in the case of a reciprocal stroke movement of the wheels 422, 424, herein a deflection at the wheel 424 on the outside of the curve, the instantaneous roll axis 426 (mᵣₒₗₗ) has a significantly higher torsional component mₜₒᵣₛᵢₒₙ 434 when compared to the camber or bending component m_{camber} 436. In this case, a desired negative camber angle occurs when the shear center 432 lies in front of the first joint 404 in the direction of travel. The camber or bending component 436 of the instantaneous roll axis mᵣₒₗₗ 426 in the vertical direction of the vehicle points upwards as long as the shear center 432 lies below the first joint 404. That results in a positive toe-in tendency. Due to the toe-in behavior under lateral force, the rate of change can be lower than with conventional twist beam axles.

If the installation space conditions are again taken into consideration, the moving of the crossmember 406 results in a regularly shaped installation space 438 extending far behind the wheel centers 418. This installation space 438 can be assigned, for example, to an electric energy storage device 440 for storing drive energy for an electric drive, which corresponds to an improved use of installation space in the rear carriage when compared to the conventional twist beam axle. Furthermore, the longitudinal struts 414 and the trailing arms 402 enclose the lateral surfaces and the crossmember 406 encloses the rear surfaces of the installation space 438, which improves safety, especially when the trailing arm 402 and the crossmember 406 are designed to be rigid.

Moreover, reference is made in particular to FIG. 1 through FIG. 3 and the associated description with regard to the rear axle 400.

The advantages of the rear axle known from document CN 105365543 A are therefore preserved. According to document CN 105365543 A, the link components can absorb part of the impact energy through targeted deformation in the event of a rear or side impact. For this purpose, axially foldable profiles are recommended due to their high absorption capacity. Furthermore, in the event of a rear impact, the wheels 422, 424 are supported on the body structures, which increases the resistance to penetration.

In addition to the preservation of the advantages of the rear axle known from document CN 105365543 A, there are further advantageous properties in the present case.

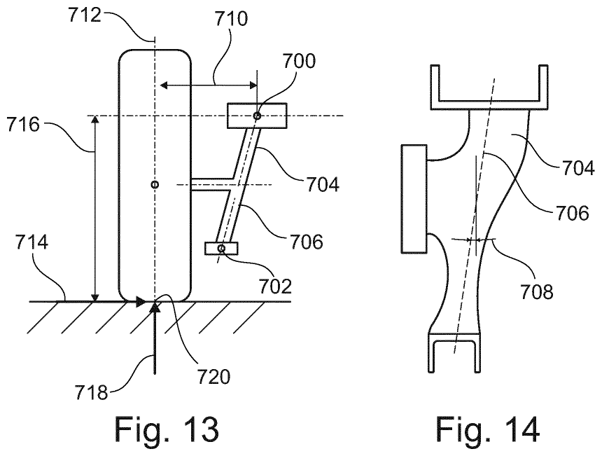

FIGS. 13 and 14 show an elastokinematic camber compensation on a rear axle, such as the rear axle 100 according to FIGS. 1 and 2, for a two-track vehicle having a Watt linkage.

According to FIGS. 13 and 14, the second joint 700 and the third joint 702 of the wheel carriers 704 are arranged offset to one another in the longitudinal direction and/or in the transverse direction (instead of one above the other in the vertical direction). Both joints 700, 702 determine an elastokinematic steering axis 706 which, by moving the second joints 700 towards the center of the vehicle and the third joints 702 towards the outside of the vehicle, is provided with a favorable inclination 708 in order to improve lateral force stiffness.

In this case, the joints 700, 702 can be designed such that the distance 710 between the center of the second joint 700 and a wheel center plane 712 is as large as possible (FIG. 13). A lateral force 714 occurring during cornering generates a torque about the first joint 700 through the lever arm 716. An increase in a wheel contact force 718 counteracts this torque. The greater the distance 710, the better the torque generated by the lateral force 714 is compensated. As a result, requirements regarding bearing stiffnesses for the second joint 700 can be reduced, which facilitates a technical realization. It is possible to aim for an inclination of the elastokinematic steering axis 706 such that the elastokinematic steering axis 706 and the wheel center plane 712 intersect at the wheel contact point 720. An angle of the elastokinematic steering axis 706 to the vertical is called an inclination 708.

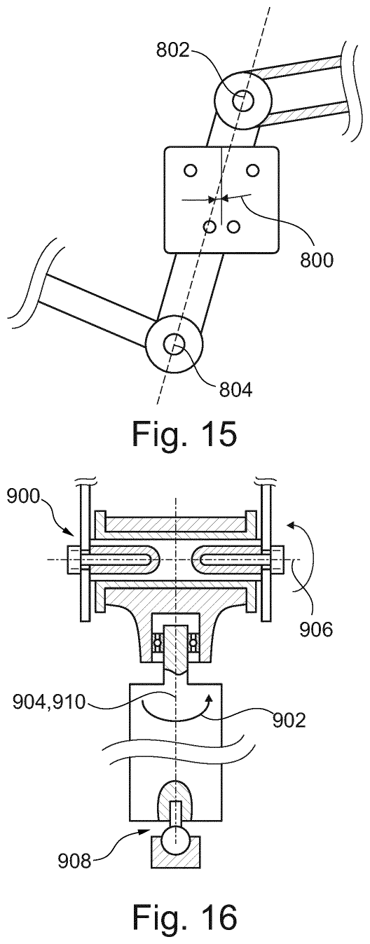

FIG. 15 shows a depiction of a caster angle 800 on a rear axle for a two-track vehicle having a Watt linkage. By offsetting the second joint 802 and the third joint 804 in relation to one another in the longitudinal direction of the vehicle, an elastokinematic caster angle 800 can be created.

FIG. 16 shows a depiction of a steerable rear axle for a two-track vehicle having a Watt linkage. For this purpose, the second joint 900 is expanded by a further rotational degree of freedom 902. In this case, this new additional axis of rotation 904 is at an angle to the original axis of rotation 906 and runs through the third joint 908. In this way, the second joint 900 and the third joint 908 define the steering axis 910 of the wheel. The third joint 908 can then be implemented as a ball joint, so that no intertwining occurs in the steering axis 910. The steering itself can then take place by means of a conventional steering system.

The springs and dampers of the axle, which can jointly or separately support the body structure on the axle side on the wheel carrier 104 or via a spring plate, are not depicted. The spring plate is fastened, for example, between the crossmember 406 and the trailing arm 402.

It is also conceivable that, in the side view, the second joint 118 is arranged between the third joint 120 and the wheel center 106. In this way, the effective distance between the roadway and the second joint 118 is reduced and the camber and lateral stability is improved. This can also have a positive effect on the brake support. A comfortable yielding of the axle in the longitudinal direction can then be set primarily via an oblique suspension of the axle.

The axle concept also offers the option of integrating a drive.

In particular, optional features of the invention are indicated by the verb “can.” Accordingly, there are also developments and/or embodiments of the invention which, additionally or alternatively, have the respective feature or the respective features.

If necessary, isolated features can also be selected from the combinations of features disclosed herein and, by dissolving any structural and/or functional relationship that may exist between the features, used in combination with other features to delimit the subject matter of the claim.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

100 Rear axle
102 Trailing arm
104 Wheel carrier
106 Wheel center
108 Wheel
110 Longitudinal strut
112 Forward direction of travel
114 Crossmember
116 First joint
118 Second joint
120 Third joint
122 Fourth joint
124 Instantaneous center of rotation
126 Lemniscate portion
128 Cylindrical joint
200 Rear axle
202 Third joint
204 Second joint
206 Integral link
208 Integral link
210 Trailing arm
212 Wheel carrier
214 Fourth joint
300 Rear axle
302 Third joint
304 Second joint
306 Integral link
308 Integral link
310 Body structure
312 Longitudinal strut
314 Fourth joint
400 Rear axle
402 Trailing arm
403 Body
404 First joint
406 Crossmember
408 Second joint
410 Wheel carrier
412 Third joint
414 Longitudinal strut
416 Fourth joint
418 Wheel center
420 Instantaneous center of rotation
422 Wheel
424 Wheel
426 Instantaneous roll axis
428 Longitudinal member
430 Roadway
432 Shear center
434 Torsional component
436 Camber or bending component
438 Installation space
440 Energy storage device
500 Second joint
502 Ball joint
504 Ball joint
506 Trailing arm
508 Wheel carrier
600 Second joint
602 Rubber element
604 Rubber element
606 Trailing arm
608 Wheel carrier
610 Pressure line
612 Pressure line
614 Spring center of gravity
700 Second joint
702 Third joint
704 Wheel carrier
706 Steering axis
708 Inclination
710 Distance
712 Wheel center plane
714 Lateral force
716 Lever arm
718 Wheel contact force
720 Wheel contact point
800 Caster angle
802 Second joint
804 Third joint
900 Second joint
902 Rotational degree of freedom
904 Additional axis of rotation
906 Original axis of rotation
908 Third joint
910 Steering axis

What is claimed is:

1-15. (canceled)

16. A rear axle for a two-track vehicle, the rear axle comprising:
a first coupling mechanism that is effective in at least one of a longitudinal direction of the vehicle or a vertical direction of the vehicle, the first coupling mechanism comprising a first trailing arm, a first wheel carrier with a first wheel center, and a first longitudinal strut;
a second coupling mechanism that is effective in at least one of the longitudinal direction of the vehicle or the vertical direction of the vehicle, the second coupling mechanism comprising a second trailing arm, a second wheel carrier with a second wheel center, and a second longitudinal strut; and
a crossmember firmly connected to the first trailing arm and to the second trailing arm, the crossmember having a shear center;
wherein the first coupling mechanism has a first instantaneous center of rotation located forward from and above the first wheel center, relative to the vehicle; and
the second coupling mechanism has a second instantaneous center of rotation located on forward from and above the second wheel center, relative to the vehicle.

17. The rear axle of claim 16, wherein the shear center of the crossmember is arranged reward from and above the wheel centers, relative to the vehicle.

18. The rear axle of claim 16, wherein:
the trailing arms are each connectable to a chassis or an underbody of the vehicle by respective first joints;
the trailing arms and the wheel carriers are each connected to one another by respective second joints;
the wheel carriers and the longitudinal struts are each connected to one another by respective third joints;
the longitudinal struts are each connectable to the chassis or the underbody by respective fourth joints; and
the first, second, third, and fourth joints have respective degrees of freedom in an installed condition such that the rear axle has two degrees of freedom, taking into account the shear center of the crossmember as a mechanically idealized cylindrical joint.

19. The rear axle of claim 18, wherein:
the first joints, the third joints, and the fourth joints each have three degrees of freedom; and
the second joints each have a one degree of freedom.

20. The rear axle of claim 18, wherein:
the first joints, the second joints, and the fourth joints each have three degrees of freedom;
the third joints each have one degree of freedom; and
the rear axle has at least one first additional link and at least one second additional link.

21. The rear axle of claim 20, wherein the additional links are designed as torque supports with integral links.

22. The rear axle of claim 18, wherein:
the first joints, the third joints, and the fourth joints each have three degrees of freedom; and
the second joints each have two degrees of freedom, such that the rear axle has a steering axis and is steerable.

23. The rear axle of claim 19, wherein:
the joints with three degrees of freedom are designed as ball joints;
the joints with two degrees of freedom are designed as combination joints with two axes of rotation or comprising two ball joints; and
the joints with one degree of freedom are designed as one of:
swivel joints,
roller bearings or slide bearings,
comprising a rubber element, or
comprising at least two rubber elements.

24. The rear axle of claim 23, wherein the joints with three degrees of freedom are designed as rubber-metal bearings.

25. The rear axle of claim 19, wherein the second joints and the third joints are each arranged offset from one another in a direction transverse to the longitudinal direction of the vehicle such that a change in camber angle of the respective wheel carrier on the outside of a curve is reduced in response to lateral forces during cornering maneuvers of the vehicle.

26. The rear axle of claim 19, wherein the second joints and the third joints are each arranged offset from one another in the longitudinal direction of the vehicle to define a predetermined caster angle.

27. The rear axle of claim 16, wherein the trailing arms are designed to be rigid and torsionally stiff.

28. The rear axle of claim 16, wherein the longitudinal struts are designed to be flexible, torsionally soft, and kink-resistant.

29. The rear axle of claim 16, wherein the fourth joints each have a lower rigidity in all directions than at least one of the first joints, the second joints, or the third joints.

30. The rear axle of claim 19, wherein the first joints and the shear center of the crossmember are arranged such that an approximately instantaneous roll axis has a torsion component that is larger than a camber component.

31. A two-track vehicle, comprising:
a chassis or an underbody; and
a rear axle according to claim 16 arranged on the chassis or the underbody.
